(19) United States
(12) Patent Application Publication
(10) Pub. No.: US 2013/0240244 A1
(43) Pub. Date: Sep. 19, 2013

(54) INSULATED WIRE AND COIL FORMED BY USING THE SAME

(71) Applicant: HITACHI CABLE, LTD., Tokyo (JP)

(72) Inventors: Yuki HONDA, Hitachi (JP); Takami USHIWATA, Hitachi (JP); Shuta NABESHIMA, Hitachi (JP); Hideyuki KIKUCHI, Hitachi (JP)

(73) Assignee: Hitachi Cable, Ltd., Tokyo (JP)

(21) Appl. No.: 13/705,081

(22) Filed: Dec. 4, 2012

(30) Foreign Application Priority Data
Mar. 13, 2012 (JP) 2012-055675

(51) Int. Cl. H01B 3/30

(52) U.S. Cl. CPC H01B 3/306
USPC 174/119 C

(57) ABSTRACT

An insulated wire includes a flat type conductor, and an insulating film on an outer periphery of the flat type conductor. The insulating film includes a polyimide layer including a polyimide and having a breaking elongation percentage of more than 80%.

The present application is based on Japanese patent application No. 2012-055675 filed on Mar. 13, 2012, the entire contents of which are incorporated herein by reference.

### BACKGROUND OF THE INVENTION

1. Field of the Invention

This invention relates to an insulated wire and, in particular, to an insulated wire configured such that an insulating film having a breaking elongation percentage of more than 80% is formed on a periphery of a flat type conductor, and a coil formed by using the insulated wire.

2. Description of the Related Art

In recent years, according to the increase in awareness of global environment conservation, it is expected that motor, transformer and the like are small-sized and highly-efficient. For example, with regard to motor, it is often the case that a high-power motor is mounted in an extremely small space.

In case of mounting a high-power motor in an extremely small space, an insulated wire having a cross-sectional shape that is a flat type shape, the insulated wire may be referred to as a flat type insulated wire, is commonly used for the purpose of heightening a space factor of a winding (a ratio of a cross-section area of a conductor to a cross-section area of the winding). In addition, in the high-power motor, for example, it is practiced that a flat type insulated wire is elongated in the longitudinal direction, and an edgewise bend processing is applied thereto, thereby a coil is formed (for example, refer to JP-B-4831125). In case of using a flat type insulated wire, a space factor of a winding can be heightened in comparison with a case of an insulated wire having a cross-sectional shape that is a round shape (the insulated wire may be referred to as a round wire).

In addition, it is often the case that an insulated wire improved in abrasion resistance with comparison with the other widely-used insulated wires is used for the above-mentioned insulated wire to which the bending process is applied, the insulated wire having an insulating film formed by using an insulating varnish including an widely-used polyamideimide resin as a base resin. For example, it is known that in the insulating varnish including the polyamideimide resin as a base resin, 3,3′-dimethylbiphenyl-4,4′-diisocyanate (hereinafter referred to as “TODI”) is used for an isocyanate component of the polyamideimide resin, so as to allow the resin skeleton of the polyamideimide resin to be rigid, thereby the insulating film can be enhanced in abrasion resistance, so that the insulating film can be prevented from an occurrence of damage such as crack during the bending process (for example, refer to JP-B-2936895 and JP-A-2007-270074).

### SUMMARY OF THE INVENTION

As described in JP-B-4831125, in case that an edgewise (namely, in the width direction of a flat type conductor) bending process is applied to a flat type insulated wire so as to form a coil, a force acts on the insulating film formed on the periphery of the flat type conductor in a direction of elongation, thus the film thickness of the insulating film formed on the periphery easily become thin, and a force acts on the insulating film formed on the inner periphery of the flat type conductor in a direction of compression, thus the film thickness of the insulating film formed on the inner periphery easily become thick. As mentioned above, in case that the bending process is applied to the flat type insulated wire, for the purpose of preventing the film thickness of the insulating film formed on the inner periphery from being thickened, a method such as pressurization via jig is used, thus a space factor of the winding becomes higher than a case that the bending process is applied to a round wire, on the other hand, stress during processing to which the insulating film is subjected is enlarged so as to cause damage such as crack in the insulating film.

As the insulated wires disclosed in JP-B-2936895 and JP-A-2007-270074, in case that an insulating film in which the resin skeleton of the polyamideimide resin configured to become rigid is used, the insulating film is enhanced in abrasion resistance, on the other hand, it becomes insufficient in flexibility. If the flexibility of the insulating film is insufficient, during a bending process such as an edgewise bend processing after elongation in which the insulating film is deformed due to severe processing stress, the insulating film cannot follow the deformation, thus damage such as crack may occur therein.

Accordingly, it is an object of the invention to provide an insulated wire that is capable of improving a space factor of winding, and preventing an occurrence of damage such as crack in the insulating film during a bending process, and a coil formed by using the insulated wire.

(1) According to one embodiment of the invention, an insulated wire comprises:

a flat type conductor (i.e., a rectangular conductor in the cross section); and

an insulating film on an outer periphery of the flat type conductor,

wherein the insulating film comprises a polyimide layer comprised of a polyimide and having a breaking elongation percentage of more than 80%.

In the above embodiment (1) of the invention, the following modifications and changes can be made.

(i) The insulating film comprises two or more insulating layers, and the insulating layers comprise a first insulating layer formed on an outer periphery of the conductor that contains an adhesion improver, and the polyimide layer formed on the outer periphery of the first insulating layer.

(ii) The polyimide layer comprises as a main component a polyimide that comprises:

an acid component (A) comprising a tetracarboxylic dianhydride of pyromellitic dianhydride or 2,2-bis[4-(3,4-dicarboxyphenoxy)phenyl]propane dianhydride; and

a diamine component (B) of 2,2-bis[4-(4-aminophenoxy)phenyl]propane, 1,3-bis (4-aminophenoxy)benzene, 4,4′-bis(4-aminophenoxy)biphenyl, bis[4-(4-aminophenoxy)phenyl]sulfone or 4,4′-diaminodiphenylether.

(iii) The first insulating layer comprises as a main component one resin of a polyamideimide, a polyimide and a polyesterimide.

(2) According to another embodiment of the invention, a coil formed by edgewise bending the insulated wire according to the above embodiment (1).

### Effects of the Invention

According to embodiments of the invention, an insulated wire can be provided that is capable of improving a space factor of winding, and preventing an occurrence of damage such as crack in the insulating film during a bending process, as well as a coil formed by using the insulated wire.

### BRIEF DESCRIPTION OF THE DRAWINGS

The preferred embodiments according to the invention will be explained below referring to the drawings, wherein:

FIG. 1 is a cross-sectional view schematically showing an insulated wire according to an embodiment of the invention; and

FIG. 2 is a perspective view schematically showing a coil according to another embodiment of the invention.

### DETAILED DESCRIPTION OF THE PREFERRED EMBODIMENTS

### Points of the Invention

With regard to a flat type insulated wire to which a bending process such as an edgewise bend processing is applied so as to form a coil, in which such a processing stress as to deform the insulating film formed on a flat type conductor is added, the inventors et al. have studied about an occurrence condition of damage such as crack in the insulating film. In addition, the inventors et al. have found that damage such as crack would not occur in the insulating film, in case that damage such as crack does not occur in the insulating film when the flat type insulating film is bent by 180 degrees in the width direction of the flat type conductor after the flat type insulating film is elongated by 40% in the longitudinal direction, even if a bending process is applied, in which such a processing stress as to deform the insulating film formed on a flat type conductor is added. Also, the inventors et al. have found that if a tensile breaking elongation characteristic of the insulating film is insufficient, damage such as crack occurs in the insulating film when the flat type insulated wire is bent by 180 degrees in the width direction of the flat type conductor after the flat type insulating film is elongated by 40%. As a result, an insulated wire that includes a flat type conductor and an insulating film with which an outer periphery of the flat type conductor is covered, wherein the insulating film includes a polyimide layer comprised of polyimide having a breaking elongation percentage of more than 80% has been adopted as a flat type insulated wire to be processed into a coil.

### Embodiments

Insulated Wire

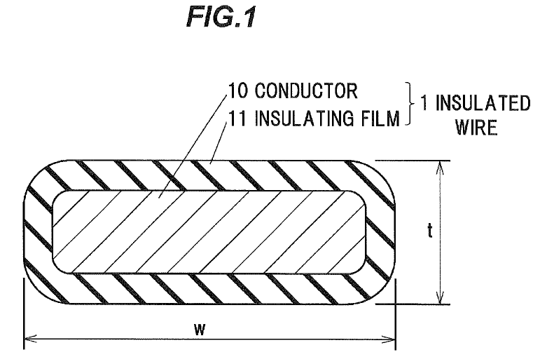

FIG. 1 is a cross-sectional view schematically showing an insulated wire 1 according to the embodiment of the invention. The insulated wire 1 is a flat type insulated wire that includes a conductor 10 and an insulating film 11 formed on the periphery of the conductor 10. Reference marks of “w” and “t” in FIG. 1 represent a width and a thickness of the insulated wire 1 respectively.

In the insulated wire 1, damage such as crack does not occur in the insulating film 11, even if a bending process is applied to the insulated wire 1, in which such a processing stress as to deform the insulating film 11 is added. For example, damage such as crack does not occur in the insulating film 11, even if the insulated wire 1 is bent by 180 degrees in the width (w) direction of the conductor 10.

The conductor 10 is a flat type conductor wire comprised of a conductive material such as copper. As the copper, oxygen free copper, low oxygen copper or the like is mostly used. In addition, the conductor 10 can have a multilayered structure, for example, an conductor configured such that metal plating such as nickel plating is applied to a surface of copper wire can be also used. The conductor 10 is configured to have a rectangular shape as a cross-sectional shape. Further, the above-mentioned rectangular shape includes a rectangular shape whose corner parts are rounded.

The insulating film 11 includes a polyimide layer comprised of a polyimide and having a breaking elongation percentage of more than 80%

The polyimide layer is formed by coating the outer periphery of the conductor 10 with a resin varnish prepared by dissolving a polyimide resin precursor into a solvent, and baking the resin varnish. The polyimide resin precursor contained in the resin varnish constituting the polyimide layer is comprised of a reactant of an acid component (A) including tetracarboxylic dianhydride and a diamine component (B).

As the acid component (A), for example, tetracarboxylic dianhydride such as pyromellitic dianhydride (PMDA), 2,2-bis[4-(3,4-dicarboxyphenoxy)phenyl]propane dianhydride, 3,3′,4,4′-biphenyl tetracarboxylic dianhydride can be used.

As the diamine component (B), an aromatic diamine including a phenolic hydroxyl group can be preferably used, for example, a diamine (a) including any of 2,2-bis[4-(4-aminophenoxy)phenyl]propane, 1,3-bis(4-aminophenoxy)benzene, 4,4′-bis(4-aminophenoxy)biphenyl, and bis[4-(4-aminophenoxy)phenyl]sulfone can be used.

The above-mentioned aromatic diamine has not less than three aromatic rings in the molecular structure, by using the aromatic diamine having not less than three aromatic rings in the molecular structure as mentioned above, an imide concentration in polyimide constituting the polyimide layer can be reduced, for example, in the range of not less than 15% and less than 36%. The imide concentration in polyimide is reduced, thereby partial discharge inception voltage of the insulating layer (polyimide layer) can be heightened.

Polyimide constituting the polyimide layer can further includes a diamine (b) including 4,4′-diaminodiphenylether (ODA). Polyimide constituting the polyimide layer includes the diamine (b), thereby heat resistance and elastic modulus under high temperature are enhanced. At this time, it is preferable that the diamine (a) and the diamine (b) comprised of 4,4′-diaminodiphenylether are blended with each other at the molar ratio of (a)/(b)=90/10 to 10/90.

In addition, the insulating film 11 can have a multilayered structure comprised of not less than two insulating layers. In this case, one layer of the multilayered structure is a polyimide layer comprised of a polyimide and having a breaking elongation percentage of more than 80%.

For example, the insulating film 11 is comprised of a first insulating layer formed on the periphery of the conductor 10, and a polyimide layer (a second insulating layer) comprised of the above-mentioned polyimide formed on the outer periphery thereof. The first insulating layer is obtained by coating the outer periphery of the conductor with a resin varnish prepared by dissolving a resin having an imide group such as polyimide, polyamideimide, polyesterimide into a solvent, and baking the resin varnish. The resin varnish used for the first insulating layer can include additives such as melamine based compounds such as an alkylated hexamethylol melamine resin, and sulfur-containing compounds typified by mercapto based compound for the purpose of improving an adhesion property to the conductor 10. Also, materials capable of developing a high adhesion property other than the above-mentioned additives can be also included.

In addition, the insulated wire 1 can include a lubricating insulating layer comprised of a lubricating material-containing resin on the outer periphery of the insulating film 11. As the above-mentioned lubricating material, a lubricating varnish configured to contain a lubricating component in an enamel varnish such as polyimide, polyesterimide, polyamideimide can be used. The lubricating component means one or not less than two selected individually or in mixture from the group consisting of polyolefin wax, fatty acid amide, and fatty acid ester. In particular, any one or a mixture of polyolefin wax and fatty acid amide is preferably used, but not limited to this. In addition, a lubricating enamel varnish configured such that a fatty acid component having a lubricating property is introduced into a chemical structure of the enamel varnish can be also used. It is preferable that the above-mentioned lubricating insulating layer is formed by coating and baking the insulating varnish.

Coil

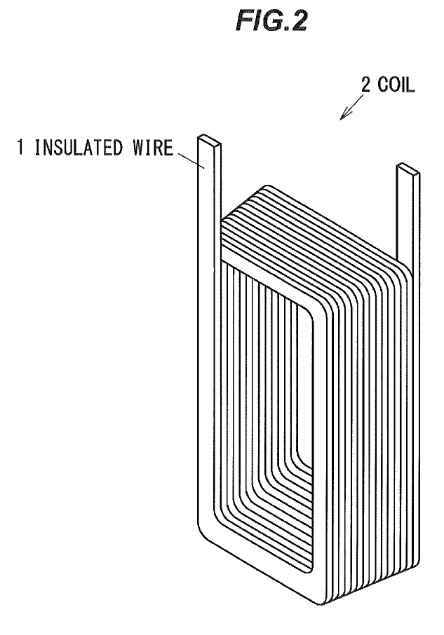

FIG. 2 is a perspective view schematically showing a coil according to an embodiment of the invention. The coil 2 is, for example, a coil constituting an electric device such as motor, electric generator, and formed by applying an edgewise bend processing to the insulated wire 1.

The coil 2 is, for example, a coil configured to be mounted on a stator core of the electric device, and formed by winding the insulated wire 1 in a trapezoidal shape in accordance with the shape of the stator core.

Advantages of Embodiment

According to the embodiment, the insulated wire 1 is a flat type insulated wire, thus the coil 2 has a high space factor of winding. In addition, the insulating film 11 of the insulated wire 1 includes a polyimide layer comprised of a polyimide and having a breaking elongation percentage of more than 80%, thus the insulating film 11 can be prevented from an occurrence of damage such as crack during the bending process. Consequently, by applying the edgewise bend processing to the insulated wire 1, the coil 2 having a good quality can be formed.

### EXAMPLES

### Synthesis of Resin Varnish

First, resin varnishes A, 1 to 7 were synthesized under the following conditions.

Resin varnish A was obtained in such a manner that 50 mol % of pyromellitic dianhydride (PMDA) and 50 mol % of 4,4′-diaminodiphenylether (ODA) were blended with each other in a flask equipped with a stirring machine, a reflux cooling tube, a nitrogen flow tube and a thermometer, and N-methyl-2-pyrolidone was blended together so as to adjust the solid content concentration to be 18 wt %, and then reaction was carried out at room temperature for 12 hours, and then an alkylated hexamethylol melamine resin was added.

Resin varnish 1 was obtained in such a manner that 50 mol % of pyromellitic dianhydride (PMDA) and 50 mol % of 2,2-bis[4-(4-aminophenoxy)phenyl]propane (BAPP) were blended with each other in a flask equipped with a stirring machine, a reflux cooling tube, a nitrogen flow tube and a thermometer, and N-methyl-2-pyrolidone was blended together so as to adjust the solid content concentration to be 18 wt %, and then reaction was carried out at room temperature for 12 hours.

Resin varnish 2 was obtained in such a manner that 50 mol % of pyromellitic dianhydride (PMDA) and 50 mol % of 1,3-bis(4-aminophenoxy)benzene (TPE-R) were blended with each other in a flask equipped with a stirring machine, a reflux cooling tube, a nitrogen flow tube and a thermometer, and N-methyl-2-pyrolidone was blended together so as to adjust the solid content concentration to be 14 wt %, and then reaction was carried out at room temperature for 12 hours.

Resin varnish 3 was obtained in such a manner that 50 mol % of pyromellitic dianhydride (PMDA), 25 mol % of 2,2-bis[4-(4-aminophenoxy)phenyl]propane (BAPP) and 25 mol % of 4,4′-diaminodiphenylether (ODA) were blended with each other in a flask equipped with a stirring machine, a reflux cooling tube, a nitrogen flow tube and a thermometer, and N-methyl-2-pyrolidone was blended together so as to adjust the solid content concentration to be 15 wt %, and then reaction was carried out at room temperature for 12 hours.

Resin varnish 4 was obtained in such a manner that 50 mol % of pyromellitic dianhydride (PMDA) and 50 mol % of 4,4-bis(4-aminophenoxy)biphenyl (BAPB) were blended with each other in a flask equipped with a stirring machine, a reflux cooling tube, a nitrogen flow tube and a thermometer, and N-methyl-2-pyrolidone was blended together so as to adjust the solid content concentration to be 18 wt %, and then reaction was carried out at room temperature for 12 hours.

Resin varnish 5 was obtained in such a manner that 50 mol % of pyromellitic dianhydride (PMDA) and 50 mol % of bis[4-(4-aminophenoxy)phenyl]sulfone (BAPS) were blended with each other in a flask equipped with a stirring machine, a reflux cooling tube, a nitrogen flow tube and a thermometer, and N-methyl-2-pyrolidone was blended together so as to adjust the solid content concentration to be 15 wt %, and then reaction was carried out at room temperature for 12 hours.

Resin varnish 6 was obtained in such a manner that 50 mol % of pyromellitic dianhydride (PMDA), 45 mol % of 2,2-bis[4-(4-aminophenoxy)phenyl]propane (BAPP) and 5 mol % of 4,4′-diaminodiphenylether (ODA) were blended with each other in a flask equipped with a stirring machine, a reflux cooling tube, a nitrogen flow tube and a thermometer, and N-methyl-2-pyrolidone was blended together so as to adjust the solid content concentration to be 15 wt %, and then reaction was carried out at room temperature for 12 hours.

Resin varnish 7 was obtained in such a manner that 50 mol % of pyromellitic dianhydride (PMDA), 5 mol % of 2,2-bis[4-(4-aminophenoxy)phenyl]propane (BAPP) and 45 mol % of 4,4′-diaminodiphenylether (ODA) were blended with each other in a flask equipped with a stirring machine, a reflux cooling tube, a nitrogen flow tube and a thermometer, and N-methyl-2-pyrolidone was blended together so as to adjust the solid content concentration to be 15 wt %, and then reaction was carried out at room temperature for 12 hours.

Measurement of the Breaking Elongation Percentage

Next, films were fabricated by using the resin varnishes A, 1 to 7, and test specimens having a dumbbell shape were fabricated by using the films. In addition, the breaking elongation percentage of the dumbbell specimens was measured by using a tensile testing machine.

As a result of the measurement, the respective breaking elongation percentages (%) of the dumbbell specimens fabricated by using the resin varnishes A, 1 to 7 were 80, 145, 95, 125, 100, 105, 120 and 90.

Measurement of the Glass-Transition Temperature

Next, insulating films were formed by coating a glass plate with the resin varnishes A, 1 to 7 respectively by using an applicator having a gap of 200 μm, and baking the resin varnishes A, 1 to 7 at 80 degrees C. for 20 minutes. Next, the insulating films were separated from the glass plate, and the end portions thereof were fixed to an iron frame by a kapton tape. Next, the insulating films were bakes at 200 degrees for 20 minutes and further at 250 degrees C. for 20 minutes, and then cut so as to have a size of 5 mm×20 mm. Next, temperature was elevated from room temperature to 350 degrees C. at the speed of 10 degrees C./min, and storage elastic modulus at the 10 Hz vibration of the insulating film 11 was measured by using a dynamic viscoelastic measurement machine (DVA-200 manufactured by IT Keisoku Seigyo Co., Ltd), and temperature at an inflection point where storage elastic modulus was lowered was defined as glass-transition temperature.

As a result of the measurement, the respective glass-transition temperature (degrees C.) of the insulating films fabricated by using the resin varnishes A, 1 to 7 were 360, 307, 360, 317, 317, 316, 308 and 340.

Manufacturing of the Insulated Wire

Next, insulated wires were manufactured under the following conditions shown in Examples 1 to 8 and Comparative Example 1, and bending test was applied to each of the insulated wires. Further, as an insulating film of the insulated wire, an insulating film having a two-layered structure was formed, the insulating film being configured such that a first insulating layer having a thickness of 0.002 mm formed on the periphery of the conductor and a second insulating layer having a thickness of 0.038 mm formed on the outer periphery of the first insulating layer.

### Example 1

The first insulating layer was formed by coating a flat type copper conductor with the resin varnish 1 and baking the resin varnish 1, and then the second insulating layer was formed by further coating with the resin varnish 1 and baking the resin varnish 1, so that an insulated wire of Example 1 was formed. In Example 1, the second insulating layer is formed of the resin varnish 1, thus the second insulating layer has breaking elongation percentage of 145% and glass-transition temperature of 307 degrees C.

### Example 2

The first insulating layer was formed by coating a flat type copper conductor with the resin varnish A and baking the resin varnish A, and then the second insulating layer was formed by further coating with the resin varnish 1 and baking the resin varnish 1, so that an insulated wire of Example 2 was formed. In Example 2, the second insulating layer is formed of the resin varnish 1, thus the second insulating layer has breaking elongation percentage of 145% and glass-transition temperature of 307 degrees C.

### Example 3

The first insulating layer was formed by coating a flat type copper conductor with the resin varnish A and baking the resin varnish A, and then the second insulating layer was formed by further coating with the resin varnish 2 and baking the resin varnish 2, so that an insulated wire of Example 3 was formed. In Example 3, the second insulating layer is formed of the resin varnish 1, thus the second insulating layer has breaking elongation percentage of 95% and glass-transition temperature of 360 degrees C.

### Example 4

The first insulating layer was formed by coating a flat type copper conductor with the resin varnish A and baking the resin varnish A, and then the second insulating layer was formed by further coating with the resin varnish 3 and baking the resin varnish 3, so that an insulated wire of Example 4 was formed. In Example 4, the second insulating layer is formed of the resin varnish 1, thus the second insulating layer has breaking elongation percentage of 125% and glass-transition temperature of 317 degrees C.

### Example 5

The first insulating layer was formed by coating a flat type copper conductor with the resin varnish A and baking the resin varnish A, and then the second insulating layer was formed by further coating with the resin varnish 4 and baking the resin varnish 4, so that an insulated wire of Example 5 was formed. In Example 5, the second insulating layer is formed of the resin varnish 1, thus the second insulating layer has breaking elongation percentage of 100% and glass-transition temperature of 317 degrees C.

### Example 6

The first insulating layer was formed by coating a flat type copper conductor with the resin varnish A and baking the resin varnish A, and then the second insulating layer was formed by further coating with the resin varnish 5 and baking the resin varnish 5, so that an insulated wire of Example 6 was formed. In Example 6, the second insulating layer is formed of the resin varnish 1, thus the second insulating layer has breaking elongation percentage of 105% and glass-transition temperature of 316 degrees C.

### Example 7

The first insulating layer was formed by coating a flat type copper conductor with the resin varnish A and baking the resin varnish A, and then the second insulating layer was formed by further coating with the resin varnish 6 and baking the resin varnish 6, so that an insulated wire of Example 7 was formed. In Example 7, the second insulating layer is formed of the resin varnish 1, thus the second insulating layer has breaking elongation percentage of 120% and glass-transition temperature of 308 degrees C.

### Example 8

The first insulating layer was formed by coating a flat type copper conductor with the resin varnish A and baking the resin varnish A, and then the second insulating layer was formed by further coating with the resin varnish 7 and baking the resin varnish 7, so that an insulated wire of Example 8 was formed. In Example 8, the second insulating layer is formed of the resin varnish 1, thus the second insulating layer has breaking elongation percentage of 90% and glass-transition temperature of 340 degrees C.

### Comparative Example 1

An insulated wire of Comparative Example 1 was formed by coating a flat type copper conductor with the resin varnish A and baking the resin varnish A. In Comparative Example 1, the second insulating layer is formed of the resin varnish A, thus the second insulating layer has breaking elongation percentage of 80% and glass-transition temperature of 360 degrees C.

Bending Test

Next, test specimens of 10 cm in length are taken from the insulated wires obtained, and the test specimens are elongated to an elongation of 40% (14 cm) by a tensile testing machine. Next, the central part of the test specimen elongated is brought contact with the outer periphery of a round bar having an outer diameter that is the same length as the width of the conductor so as to be perpendicular to the outer periphery of the round bar, and 180 degrees edgewise bend processing is applied to the central part of the test specimen brought contact with the round bar while kept in one plane. At this time, it is visually observed whether crack through which the conductor can be seen occurs in the insulating film of the test specimen bent by 180 degrees or not, and the test specimen in which crack does not occur is judged as “pass” and the test specimen in which crack occurs is judged as “fail”.

As a result of the test, the insulated wires of Examples 1 to 8 were corresponding to “pass” and the insulated wires of Comparative Example 1 was corresponding to “fail”.

Table 1 shows characteristics of the insulated wires of Examples 1 to 8 and Comparative Example 1 obtained by the above-mentioned measurement and test.

TABLE 1

| | | | Example | Example | Example | Example | Example | Example | Example | Example | Comparative |
|---|---|---|---|---|---|---|---|---|---|---|---|
| Item | | | 1 | 2 | 3 | 4 | 5 | 6 | 7 | 8 | Example 1 |
| Insulating | First | Type | Resin | Resin | Resin | Resin | Resin | Resin | Resin | Resin | Resin |
| film | insulating | | varnish 1 | varnish A | varnish A | varnish A | varnish A | varnish A | varnish A | varnish A | varnish A |
| | layer | Thickness | 0.002 | 0.002 | 0.002 | 0.002 | 0.002 | 0.002 | 0.002 | 0.002 | 0.002 |
| | | (mm) | | | | | | | | | |
| | Second | Type | Resin | Resin | Resin | Resin | Resin | Resin | Resin | Resin | Resin |
| | insulating | | varnish 1 | varnish 1 | varnish 2 | varnish 3 | varnish 4 | varnish 5 | varnish 6 | varnish 7 | varnish A |
| | layer | Thickness | 0.038 | 0.038 | 0.038 | 0.038 | 0.038 | 0.038 | 0.038 | 0.038 | 0.038 |
| | | (mm) | | | | | | | | | |

| | | | | | | | | | |
|---|---|---|---|---|---|---|---|---|---|
| Imide concentration | 23.62 | 23.62 | 29.51 | 28.72 | 25.43 | 22.78 | 24.49 | 34.71 | 36.62 |
| (%) of second insulating layer | | | | | | | | | |
| Breaking elongation percentage | 145 | 145 | 95 | 125 | 100 | 105 | 120 | 90 | 80 |
| (%) of second insulating layer | | | | | | | | | |
| Glass-transition temperature | 307 | 307 | 360 | 317 | 317 | 316 | 308 | 340 | 360 |
| (degrees C.) | | | | | | | | | |
| 180 degrees bending test after | Pass | Pass | Pass | Pass | Pass | Pass | Pass | Pass | Fail |
| 40% elongation (edgewise bending) | | | | | | | | | |

As shown in Table 1, the insulated wires of Examples 1 to 8 configured such that breaking elongation percentage (%) of the second insulating layer is not less than 90% pass the bending test, and the insulated wire of Comparative Example 1 configured such that breaking elongation percentage (%) of the second insulating layer is 80% fails the bending test. From this, it can be said that in case of applying a bending process which allows an insulating film to be deformed to an insulated wire, for the purpose of preventing the insulating film from being damaged, it is necessary for breaking elongation percentage (%) of the second insulating layer to be more than 80%, and it is preferable for breaking elongation percentage (%) of the second insulating layer to be not less than 90%.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulated wire, comprising:
a flat type conductor; and
an insulating film on an outer periphery of the flat type conductor,
wherein the insulating film comprises a polyimide layer comprised of a polyimide and having a breaking elongation percentage of more than 80%.

2. The insulated wire according to claim 1, wherein the insulating film comprises two or more insulating layers, and
wherein the insulating layers comprise a first insulating layer formed on an outer periphery of the conductor that contains an adhesion improver, and the polyimide layer formed on the outer periphery of the first insulating layer.

3. The insulated wire according to claim 1, wherein the polyimide layer comprises as a main component a polyimide that comprises:
an acid component (A) comprising a tetracarboxylic dianhydride of pyromellitic dianhydride or 2,2-bis[4-(3,4-dicarboxyphenoxy)phenyl]propane dianhydride; and
a diamine component (B) of 2,2-bis[4-(4-aminophenoxy)phenyl]propane, 1,3-bis (4-aminophenoxy)benzene, 4,4′-bis(4-aminophenoxy)biphenyl, bis[4-(4-aminophenoxy)phenyl]sulfone or 4,4′-diaminodiphenylether.

4. The insulated wire according to claim 2, wherein the first insulating layer comprises as a main component one resin of a polyamideimide, a polyimide and a polyesterimide.

5. A coil formed by edgewise bending the insulated wire according to claim 1.
